(19) United States
(12) Patent Application Publication
(10) Pub. No.: US 2026/0162298 A1
(43) Pub. Date: Jun. 11, 2026

(54) METHOD FOR RETRIEVING A TARGET POSITION IN A MICROSCOPIC SAMPLE IN AN EXAMINATION APPARATUS USING POSITION RETRIEVAL INFORMATION, METHOD FOR EXAMINING AND/OR PROCESSING SUCH A TARGET POSITION AND MEANS FOR IMPLEMENTING THESE METHODS

(71) Applicant: Leica Microsystems CMS GmbH, Wetzlar (DE)

(72) Inventors: Frank SIECKMANN, Wetzlar (DE); Frank HECHT, Wetzlar (DE)

(21) Appl. No.: 18/705,599

(22) PCT Filed: Nov. 2, 2021
(86) PCT No.: PCT/EP2021/080384

§ 371 Date: Apr. 29, 2024

(51) Int. Cl. G06T 7/73; G02B 21/36; G06V 10/24

(52) U.S. Cl. CPC G06T 7/74; G02B 21/365; G06V 10/245; G06T 2207/10061

(57) ABSTRACT

A method for retrieving a target position in a microscopic sample using position retrieval information, the position retrieval information including a set of geometric descriptors describing a spatial relation between a target position identifier and a plurality of reference position identifiers corresponding to positions of a plurality of reference markers. The method includes providing a representation of the sample or a region thereof expected to comprise the target position; specifying a potential one of the reference markers associated to the target position in the representation; providing digital distance representations of the individual reference marker distances of the plurality of reference markers associated to the target position in a form of rotational traces coaxially centred around the potential one of the reference markers specified; and identifying a feature in the representation as potentially being the target position based on an evaluation of the representation and the digital distance representations.

### CROSS REFERENCE TO RELATED APPLICATIONS

This application is a U.S. National Phase application under 35 U.S.C. § 371 of International Application No. PCT/EP2021/080384, filed on Nov. 2, 2021. The International Application was published in English on May 11, 2023 as WO 2023/078532 A1 under PCT Article 21(2).

### FIELD

The present invention relates to a method for retrieving a target position in a microscopic sample in an examination apparatus using position retrieval information, a method for examining and/or processing a microscopic sample at such a target position, and means for implementing these methods in the form of an apparatus, an examination arrangement and a computer program.

### BACKGROUND

As mentioned in C. Kizilyaprak et al., “Focused ion beam scanning electron microscopy in biology”, J. Microsc. 254(3), 109-114, focused ion beam scanning electron microscopy (FIB-SEM) is progressively used in biological research. A focused ion beam scanning electron microscopy instrument is a scanning electron microscope (SEM) with an attached gallium ion column in which beams of electrons and ions may be focused to coincident points.

One application of focused ion beam scanning electron microscopy is the acquisition of three-dimensional tomography data wherein, with the ion beam, thin layers of the surface at a target region are repetitively removed and the remaining block-face is imaged with the electron beam in a likewise repetitive manner. A focused ion beam scanning electron microscopy instrument can also be used to cut open structures for getting access to internal structures or to prepare thin lamellas for imaging by (cryo-) transmission electron microscopy.

### SUMMARY

In an embodiment, the present disclosure provides a method for retrieving a target position in a microscopic sample in an examination apparatus using position retrieval information. The position retrieval information includes, associated to the target position, a set of geometric descriptors describing a spatial relation between a target position identifier corresponding to the target position and a plurality of reference position identifiers corresponding to positions of a plurality of reference markers associated to and identifiable in individual reference marker distances to the target position in the microscopic sample. The method includes a) providing a digital sample representation of the sample or a region thereof expected to include the target position; b) specifying a potential one of the reference markers associated to the target position in the digital sample representation; c) providing digital distance representations of the individual reference marker distances of the plurality of reference markers associated to the target position in a form of rotational traces coaxially centred around the potential one of the reference markers specified; and d) identifying a feature in the digital sample representation as potentially being the target position based on an evaluation of the digital sample representation and the digital distance representations.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a microscopic sample;

FIG. 2 illustrates a geometrical descriptor set;

FIG. 3 illustrates categories in defining a geometrical descriptor set;

FIG. 4 illustrates rotational traces of reference position distances around a target position;

FIG. 5 illustrates aspects of identifying a target position in a perspective view;

FIG. 6 illustrates aspects of identifying a target position in a perspective view;

FIG. 7 illustrates aspects of identifying a target position using intersecting rotational traces;

FIG. 8 illustrates an outcome when a false reference is used for a target position;

FIG. 9 illustrates rotating a geometrical descriptor set in a plane view;

FIG. 10 illustrates rotating a geometrical descriptor set in a perspective view;

FIG. 11 illustrates a method in the form of a flow diagram;

FIG. 12 illustrates a computerized microscope system; and

FIG. 13 illustrates microscope arrangement.

### DETAILED DESCRIPTION

In an embodiment of the present invention, a method for retrieving a target position in a microscopic sample in an examination apparatus using position retrieval information is proposed, the position retrieval information comprising, associated to the target position, a set of geometric descriptors describing a spatial relation between a target position identifier corresponding to the target position and a plurality of reference position identifiers corresponding to positions of a plurality of reference markers associated to and identifiable in individual reference marker distances to the target position in the microscopic sample.

In an embodiment, the method comprises (a) providing a digital sample representation of the sample or a region thereof expected to include the target position, (b) specifying a potential one of the reference markers associated to the target position in the sample representation, (c) providing digital distance representations of the individual reference marker distances of the plurality of reference markers associated to the target position in the form of rotational traces coaxially centred around the potential one of the reference markers specified, and (d) identifying a feature in the sample representation as potentially being the target position and/or the potential one of the reference markers as being one of the reference markers on the basis of an evaluation of the sample representation and the digital distance representations.

The term “target positions”, as used herein, particularly relates to positions of a sample which are to be worked on in an examination or processing apparatus or method such as, but not limited to, ion beam scanning electron microscopy. Using the instrumentalities as proposed herein, a retrieval of such target positions is significantly improved because position information provided accordingly allow for an easy and reliable identification of patterns including the target position.

A “(digital) sample representation” may be a digital image which may or may not be composed, combined, or synthesized from a plurality of images or image regions with identical or different focus settings or covering the same or different image regions, such as by stitching or merging different image layers. A digital representation may be a focus map combining different partial images in each of which different focus settings are present.

Particularly if techniques comprising different imaging modalities are used for providing and retrieving position information, retrieval of information, as found by the present inventors, sometimes becomes difficult. In other words, data and position information defined using a light microscope are not easily recognized in an electron microscope. Similar considerations apply for other examination methods and apparatus. The instrumentalities proposed herein overcome this problem.

Generally, as “reference markers”, fluorescence beads or so called quantum dots as known in the field of fluorescence microscopy, e.g. with a size of up to 1 μm or more specifically with a size of 10 to 500 or 50 to 200 nm may be used. Such beads may be provided as beads with different fluorescence responses in the optical spectrum. Quantum dots also have the advantage that they do not fade when exposed to light for a long time. Quantum dots are therefore customizable light points that shine with undiminished brightness. There is no limitation as to the specific types of beads and any other types of reference markers may be used, which preferably are also identifiable in a different type of microscopy than the type of microscopy in which the target positions are to be retrieved. In a preferred embodiment, the reference markers may be distributed randomly in the sample. The term “optically detectable” shall refer to any type of detection of an optic response, e.g. in the visible or non-visible range of the light spectrum.

The term “position identifier” shall generally refer to any form of data defining a position, such as, but not limited to, pixel coordinates in an overview scan, coordinates defined in relation to a base point, such as defined on a microscope stage, a sample carrier, the sample, an image obtained from the sample, etc. The term “coordinates” is to be understood broadly herein and shall refer to Cartesian, polar, and any other form of coordinates conceivable, such as, in particular, pixel counts in an image. In relation to particular embodiments of the present invention, position markers may also be derived based on an estimate of a position by suitable interpolation from positions or otherwise detected. Thus, subpixel interpolation methods can estimate an intermediate position value between two pixels.

The subpixel interpolation (especially in the three dimensions X, Y and Z) can be represented visually. Thus, a visual representation and a position measurement can be made in the subpixel area of an image when this relatively blurred image is presented to a human. The human brain is able to recognize a structure and certain objects even in blurred images. According to embodiments of the present invention, this makes a kind of localization microscopy possible because the combination of a visual presentation of an interpolated subpixel image and a position marker within this image by a human enables the human to mark a position in the subpixel area corresponding to X, Y and Z coordinates, and thus to achieve a significantly increased spatial resolution.

In an embodiment, using a specific type of position retrieval information which may be visualized to a user of an electron microscope or other examination apparatus, retrieval of positions of interest as previously defined e.g. in a light or fluorescence microscope is significantly improved. In this context, particularly human pattern perception is supported by creating a suitable pattern which can be visually superimposed on an image obtained in the examination method such as electron microscopy and which gives the human user a clue as to which pattern to look for. This allows for a purposeful conditioning of human senses with a search pattern that makes it easier for a person to recognise and find a certain pattern in a complex environment. In this connection, furthermore, logical support of the human user in case the user is of the opinion he or she has found a part of a visual pattern may be provided. That is, based on descriptors such as certain graphs, further parts of a visual search pattern may be suggested.

In an embodiment, the digital sample representation and the digital distance representations may particularly be provided in an overlaid manner in a display region of a graphical user interface rendered by a computing device on a display. Furthermore, specifying the potential one of the reference markers associated to the target position in the sample representation may particularly include receiving and processing a user input of a user of the computing device indicating a position in the display region. A user is therefore enabled to perform an intuitive comparison between a pattern and an underlying image including shifting, moving, rotating and tilting the pattern and/or the underlying image before finally indicating a position. It should be understood that digital pattern representations are preferably three-dimensional patterns. If these patterns are viewed from different directions, the patterns are displayed distorted in perspective according to the viewing direction. For example, a circle in plain view (e.g., in an optical microscope image) can be displayed at a certain angle in an electron microscope, so that circles in one view become ellipses in the other perspective view.

The digital sample representation may be provided in a perspective view and the distance representations may be provided in the same perspective view as apparent ellipses. However, the digital sample representation may also be provided in a top view and the digital distance representations may be provided in the same top view as circles. The representation is therefore advantageously adapted to the respective views in any of the instruments used, and the distance representations are translated from their original form into a corresponding view, if necessary.

Identifying the feature in the sample representation as potentially being the target position and/or the potential one of the reference markers as being one of the reference markers may include performing a pattern comparison of a pattern potential reference markers with the plurality of reference position identifiers. Human perception of patterns may be supported by displaying patterns of the reference markers in an intuitive way.

Said pattern comparison may in particular embodiments be preceded by a step restricting possible pattern orientations using the reference markers. This significantly reduces the number of patterns to look for and to compare, either by a human user or an algorithm.

As mentioned before already, in an embodiment a method is provided herein for retrieving a target position in a microscopic sample in an examination apparatus using position retrieval information, and the method may comprise a step (a) of providing a digital sample representation of the sample or a region thereof expected to include the target position, a step (b) of specifying a potential one of the reference markers associated to the target position in the sample representation, a step (c) of providing digital distance representations of the individual reference marker distances of the plurality of reference markers associated to the target position in the form of rotational traces coaxially centred around the potential one of the reference markers specified, and a step (d) of identifying a feature in the sample representation as potentially being the target position and/or the potential one of the reference markers as being one of the reference markers on the basis of an evaluation of the sample representation and the digital distance representations. Method steps (b) to (d) may be performed, in corresponding embodiments, one or a plurality of further times including specifying one or a plurality of further potential ones of the reference markers associated to the target position in the sample representation. This approach allows for a step-wise reduction of the number of possible orientations of a pattern such that the effort for finding a match is likewise reduced each time these method steps are performed.

Whenever method step (b) is performed in such embodiments, digital distance representations may be provided and identifying the feature in the sample representation as potentially being the target position may include identifying intersections between the digital distance representations. As reference and target points may be found only at such intersections, this approach eliminates the need for searching all along the digital distance representations.

The position retrieval information used in an embodiment of a method as provided herein may comprise, associated to the target position, a set of geometric descriptors. The set of geometric descriptors and/or the digital distance representations may be geometrically adapted to compensate for a shrinkage of the sample. This has the particular advantage that a reliable retrieval of positions is possible also in cases in which e.g. water evaporating or sublimating from ice in a vacuum, causing the sample to shrink and the positions of the target and reference points to shift in a certain way, is possible.

In an embodiment, in order to evaluate a quality of a result obtained by method as provided herein, a quality descriptor indicating a match between the set of geometric descriptors and the target position and reference markers may be determined and used to describe at least one of a shrinkage and a linear or nonlinear distortion of the sample. Using quality thresholds in this connection may help to differentiate between position deviations due to a shrinkage and false-positive hits. Furthermore, comparing displacements may also serve to differentiate to linear and non-linear transformations.

A method for examining and/or processing a target position and means for implementing the proposed methods in the form of an apparatus adapted to perform a corresponding method, a microscopic examination arrangement, and a computer program are also proposed according to embodiments of the present invention.

In the Figures, which will now be further explained in connection with features of embodiments of the present invention, elements, method steps, apparatus features, etc., of similar or identical construction and/or function are indicated with like reference numerals. Explanations relating to process units or components likewise relate to corresponding method steps and vice versa.

Structures to be worked on using focused ion beam scanning electron microscopy techniques (referred to as “target positions” hereinbelow) may be identified in a light or fluorescence microscope wherein a sample carrier with a microscopic sample is imaged, and coordinates or other geometric descriptors of the target positions are defined. The sample carrier with the sample may then be transferred to the focused ion beam scanning electron microscopy instrument together with the target position coordinates or descriptors, and the target positions are processed in the focused ion beam scanning electron microscopy instrument accordingly in order to find the section of interest. The microscopic sample may be a cell, a group or association of cells, a tissue or any other type of biological or non-biological matter affixed to the carrier which may be examined in a light or fluorescence microscope to define target positions. In the focused ion beam scanning electron microscopy technique, using the ion beam, ultrathin sections (“lamellas”) may be formed from such a sample thereafter, which are thin enough to be imaged in transmission electron microscopy. Embodiments of the present invention may be used to ensure that a target position identified in the light or fluorescence microscope, such as defined by X, Y and Z coordinates, is contained in the ultrathin section prepared by the ion beam scanning electron microscopy technique.

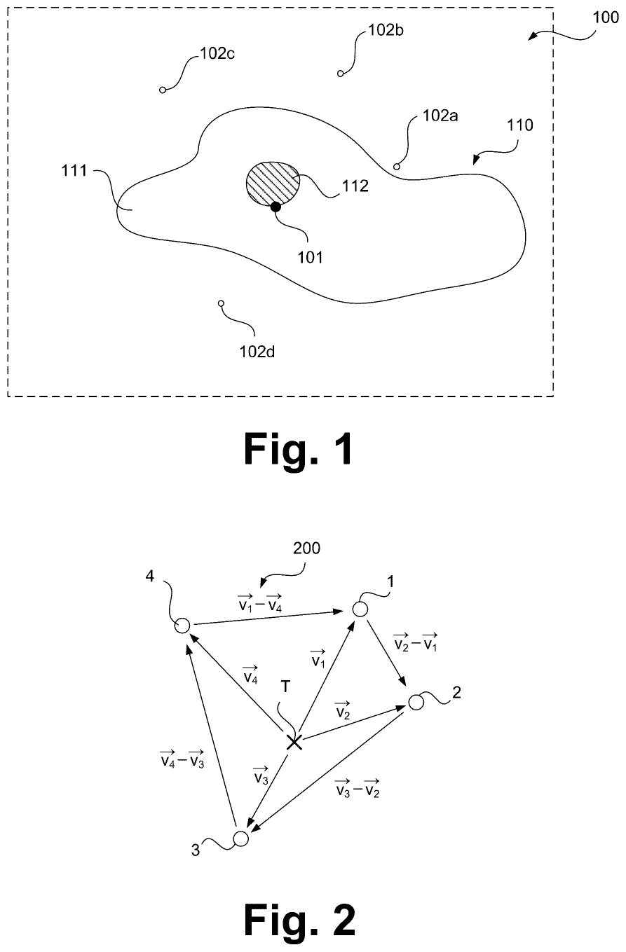

FIG. 1 illustrates such a microscopic sample 100 observed or operated on in a method according to an embodiment of the present invention. Sample 100 may be prepared according to a process generally known in the art. Sample 100 may include different sample compartments or regions such as, in the example shown in FIG. 1, a cell 110 including a nucleus 112 and a protoplasm 111. Furthermore, sample 100 includes a target position 101 and a plurality of reference markers 102a to 102d. As to the terms “target position” and “reference markers”, reference is made to the corresponding explanations above.

Be it again noted that embodiments of the present invention are not limited to one of the focused ion beam scanning electron microscopy techniques as outlined before but can likewise be used with other processing or examination methods in which target positions are first defined in an examination device or using an examination method and such target positions are then to be retrieved and processed in a processing device or method. Only for reasons of conciseness, and without any intended limitation, reference is made to a “light or fluorescence microscope” or “light or fluorescence microscopy” and to an “electron microscope” or “electron microscopy” herein. A processing device or examination apparatus may also be a laser microdissection device or method. In the latter, examination and processing may also be performed in the same instrument, even on the same device but at different times.

FIG. 2 illustrates a set of geometrical descriptors usable in a method according to an embodiment of the present invention, wherein the set of geometrical descriptors is referred to with 200. The set of geometrical descriptors 200 describes a spatial relation between a target position identifier referred to with T corresponding a target position in a sample such as target position 101 in sample 100 according to FIG. 1, and a plurality of reference position identifiers 1 to 4 corresponding to positions of a plurality of reference markers such as reference markers 102a to 102d in sample 100 according to FIG. 1.

The reference position identifiers 1 to 4 are, in the example shown, associated to and identifiable in individual reference marker distances to the target position in the microscopic sample. Herein, the position identifier T and the reference position identifiers 1 to 4 are defined as nodes in a coherent graph, and each edge corresponds to a vector as illustrated in FIG. 2. Edges between the target position identifier T and the reference position identifiers 1 to 4 define the individual reference marker distances to the target position, but these may also be defined in different way.

The properties of the graph shown in FIG. 2, i.e. the set of geometric descriptors 200 include a preferentially star-shaped arrangement with the target position identifier T in the centre and only one the target position identifier T being present.

In the set of geometric descriptors 200, at least one reference position identifier 1 to 4 but more favourable are at least two reference position identifiers 1 to 4 and, in the example shown, four reference position identifiers 1 to 4 are present. The set of geometrical descriptors 200 defines a recognizable pattern with a plurality of reference position identifiers 1 to 4 and only one target position identifier T. The invention is, at least in a particular embodiment, based on recognisability of such a pattern, by a human user and with the help of additional information relating to the individual reference marker distances to the target position being provided.

The markers of the edges of the graph forming the set of geometrical descriptors 200 are vectors. Thus, the distance of each reference position identifiers 1 to 4 node to the target position identifier T is known. Two adjacent edge markings or edge vectors in such a graph define an angle α_{1,2} according to

$${α}_{1 , 2} = ar cos ( \frac{\vec{V 2} * \vec{V 1}}{\vert \vec{V 2} \vert * \vert \vec{V 1} \vert} )$$

The direction of the graph may be defined to correspond to the direction of the edge with the maximum length. The node degree of the nodes corresponding to the reference position identifiers 1 to 4 corresponds to the number of reference position identifiers 1 to 4.

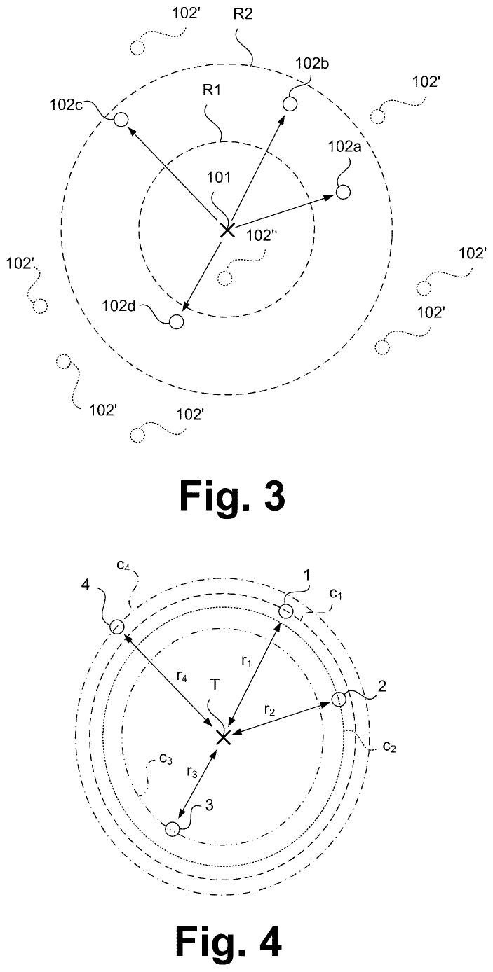

The set of geometric descriptors 200 may, in particular embodiments of the present invention, be displayed or presented to a user in the form of a pattern as already mentioned above and further explained below. Particularly the distances of the individual reference position identifiers 1 to 4 to the target position identifier T, which make an unequivocal identification of the reference markers and ultimately the position of interest possible (where e.g. a lamella for the electron microscope is to be milled out), are advantageously used in embodiments of the present invention. These distances are in virtually all but exceptional cases in which a target position is in the exact geometrical centre of reference markers which all have the same distance to the target position (a situation which practically does not occur in real life) all different from each other and thus allow for embodiments of the invention to be practiced. However, according to embodiments of the present invention, the reference markers may be selected such that these distances are, as now illustrated in an embodiment in connection with FIG. 3, in a certain distance range.

FIG. 3 illustrates, in more general terms, categories used in defining a geometrical descriptor set 200 according to an embodiment of the present invention. As illustrated, an identified target position 101 may be surrounded by a larger plurality of reference markers 102a to 102d, 102′, of which, however, only a subset, the reference position identifiers 102a to 102d already shown and discussed before, may be used to form the set of geometrical descriptors 200 while reference position identifiers 102′, which are additionally illustrated with dotted lines, are not considered. A decision as to whether include or not include reference position identifiers 102a to 102d, 102′ may particularly be made based on a determination whether these are arranged in a distance range limited by a minimum distance R1 and a maximum distance R2, in order to limit a lower and upper size of a corresponding pattern and therefore define the distance range.

A digital representation may, in particular embodiments of the present invention, be a digital image acquired based on electron microscopy or another examination method, and the digital representation may be displayed on a graphical user interface and may be presented to a user for comparison with a visualization of the position retrieval information. As further discussed below, embodiments of the present invention may include method or process steps in which the visualized position retrieval information, or parts thereof, may be virtually rearranged or moved in the digital sample representation or overlaid thereto, such that a pattern recognition by a user is therefore further simplified, as will now be explained for embodiments of the present invention on the basis of the subsequent FIGS. 4 to 7.

In this connection, FIG. 4 illustrates rotational traces of reference position distances around a target position, wherein at least in part the explanations given in connection with FIGS. 1 and 2 apply. Again, the set of geometric descriptors 200 is shown to describe a spatial relation between a target position identifier T corresponding to a target position 101 in a microscopic sample and a plurality of reference position identifiers 1 to 4 corresponding to positions of a plurality of reference markers 102a to 102d associated to and identifiable in individual reference marker distances to the target position 101 in the microscopic sample 100. Alternatively to the illustration according to FIG. 2, where the individual reference marker distances are displayed as edges in a graph, these are shown here as radii r₁ to r₄.

Circles c₁ to c₄ defined by radii r₁ to r₄ are visualized in FIG. 4 as rotational traces around the target position identifier T in the form of lines of different patterns. As the individual reference marker distances are preferably different, according to an embodiment of the present invention, all of these circles are different and can be discerned. The circles c₁ to c₄ defined by radii r₁ to r₄ as illustrated in FIG. 4 are rotational traces illustrating the individual reference marker distances the target position identifier in a top view.

In embodiments of the present invention, the method includes that a potential one of the reference markers associated to the target position is identified in the sample representation, particularly by a user. In other words, e.g. a user may select, in the sample representation, a feature, which may correspond to one reference marker of the position retrieval information currently under consideration. It is, however, at this point still open whether this user selection was correct. The next steps, therefore, may be performed, in embodiments, to verify if indeed a reference marker belonging to the set included in the position retrieval information under consideration was selected, and, if yes, which reference marker this was. A corresponding embodiment of the present invention provides an advantageous solution to this problem.

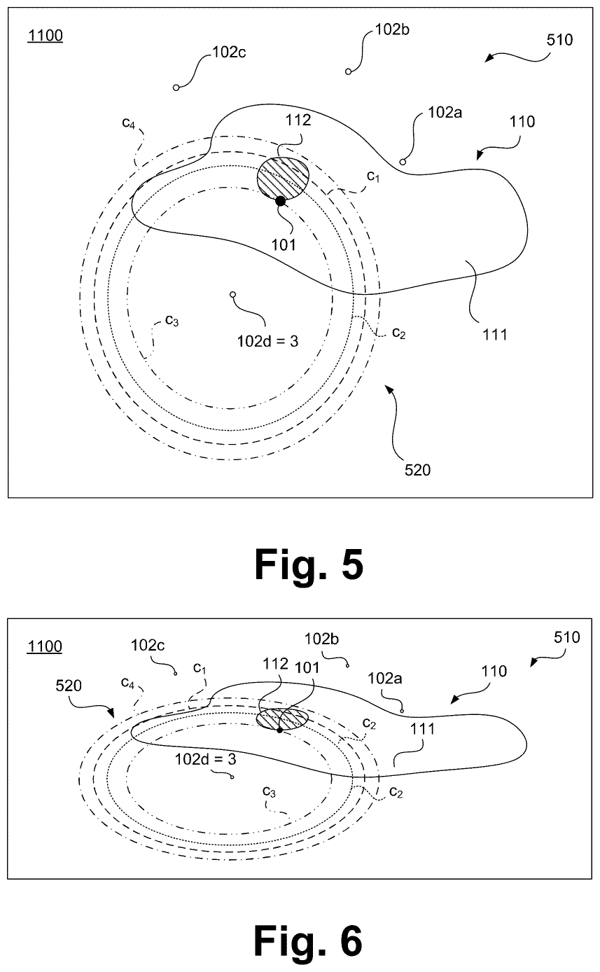

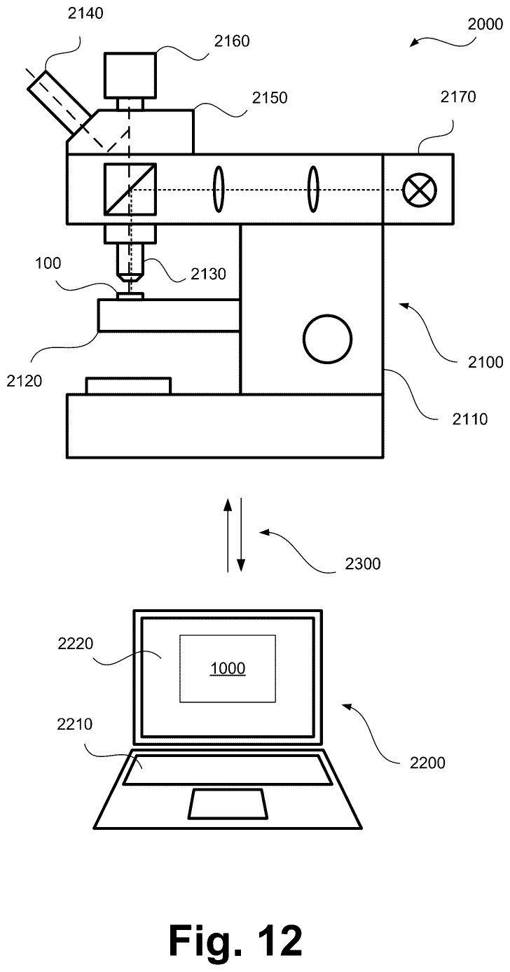

This is illustrated in connection with FIG. 5 wherein, in an example, reference marker 102d, corresponding to reference position identifier 3 and associated to reference position 101 is identified and rotational traces of individual reference marker distances, essentially already explained in connection with FIG. 4, are overlaid to an image. Particularly, as illustrated in FIG. 5, a digital sample representation 510 of a sample such as the sample 100 shown in FIG. 1 or a region thereof expected to include a target position such as the target position 101 shown in FIG. 1 is provided, particularly in a display region 1100 of a graphical user interface such as the graphical user interface 1000 according to FIG. 12 explained below.

As shown in FIG. 5, in other words, a potential one of the reference markers 102a to 102d associated to the target position 101 in the sample representation 510 is identified. In the example shown, this is the reference marker 102d additionally referred to with reference numeral 3. As shown in FIG. 5, digital distance representations 520 of the individual reference marker distances of the plurality of reference markers 102a to 102d associated to the target position 101 are now provided in the form of rotational traces coaxially centred around the potential one of the reference markers 101 specified, i.e. the reference marker 102d additionally referred to with reference numeral 3 in FIG. 5.

On this basis, a feature in the sample representation 510 can now be identified as potentially being the target position 101 by virtue of it lying on one of the digital distance representations 520, i.e. the rotational traces of the individual distances, i.e. circles c₁ to c₄. This also allows for the potential one of the reference markers 102d selected to be confirmed as being one of the reference markers 102d on the basis of it lying on circle c₃ corresponding to the distance to this reference marker 102d.

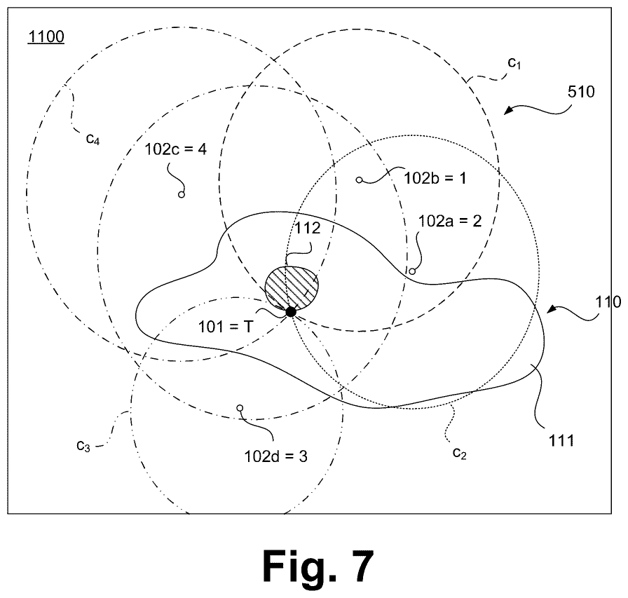

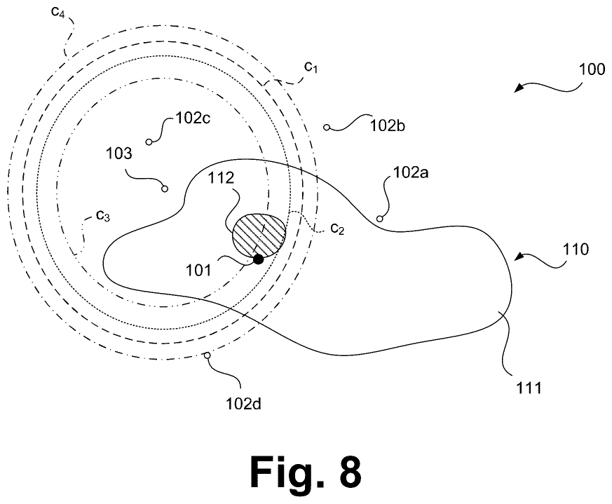

Hereinbefore, when describing FIGS. 1 to 5, a simplified view was taken which includes that the sample 100 with its target position and reference markers 101, 102a to 102d lies in a flat plane which is observed from the top. However, as also mentioned in electron microscopy, particularly in the techniques mentioned at the outset, a sample surface is often observed from an elevation angle, i.e. slanted in a certain angle vis-à-vis a line orthogonal to its surface. This is illustrated in FIG. 6 which particularly shows that the digital sample representation 510 is provided in a perspective view and that the distance representations 520 are provided in the same perspective view as apparent ellipses.

In an embodiment, if one potential reference marker 102a to 102d was identified in the electron microscopic image, it still must be confirmed whether this potential reference marker is one of the reference markers associated to the target position 101 or the target position identifier T or not (when this was a false guess). If the potential reference marker 102a to 102d is confirmed to be one of those associated to the target position 101 or the target position identifier T, the target position identifier T must logically be located in one of the individual distances and one of the representations, i.e. one of the rotational traces, must coincide with the target position identifier. If now all individual distances of reference marker identifiers to the target position identifier are visualized in the representation, i.e. in the form of concentric rotational traces, a clue may be given to the user where the target position identifier T may be located. This is already illustrated in connection with FIGS. 5 and 6 already where the target position 101 is located on trace or circle c₃.

This approach, in other words, allows for identifying a potential target position by virtue of it lying on one of the rotational traces. The target position that has been tentatively identified in this manner is, however, still not finally confirmed. For further confirmation, the method may, in an embodiment, proceed with a further potential reference position and so forth, ultimately allowing for an unequivocal identification of the whole set of positions. Further similar steps may therefore be included, e.g. for further potential reference markers rotational traces coaxially centred on or around these reference further potential reference markers may be displayed. Particularly intersections of traces for different potential reference markers allow, a stepwise restriction in possible locations of further reference markers and, ultimately, the target position. For example, a target position must be at the position of the intersection of all corresponding rotational traces around the reference position identifiers. In all cases, the gradual restriction of the initially very large set of possibilities of pattern arrangement may also gradually increase the likelihood that a human operator will recognise a pattern to be that he or she was looking for in the sample, i.e. in the electron microscopic image thereof.

FIG. 7 illustrates aspects of identifying a target position 101 using intersecting rotational traces. As illustrated, when rotational traces in the form of the circles c₁ to c₄ are drawn around all the reference position identifiers 1 to 4 in the sample representation 510 (only one rotational trace is shown around each of the reference position identifiers 1 to 4 but the explanations likewise apply when all of them are drawn), a common intersection point of all of these traces indicates the target position 101 and its identifier T.

FIG. 8 illustrates an outcome when a false reference is used for a target position where essentially the same explanations as for FIG. 5 apply. As herein, as illustrated with a point 103, a “wrong” reference marker is selected, none of the circles c₁ to c₄ coincides with the target position 102a to 102d and an identification cannot be made.

Identifying a feature in the sample representation as potentially being the target position and/or identifying the potential one of the reference markers as being one of the reference markers based on an evaluation of the sample representation and the digital distance representations, as explained in connection with FIGS. 1 to 7 before, may generally be performed by a user, but also by methods of pattern recognition in a computer. The particular advantage hereof is the simplification of such a recognition by supporting human pattern perception and/or by restricting possible locations of (further) reference positions and target positions.

In all cases, the digital sample representation and the digital distance representations may be provided in an overlaid manner in a display region of at least one graphical user interface rendered by at least one computing device on a display, as mentioned, and specifying the potential one of the reference markers associated to the target position in the sample representation includes receiving and processing a user input of a user of the computing device indicating a position in the display region. In particular embodiments, by using a graphical user interface, the presentation of the position retrieval information and information derived therefrom may be made in a manner particularly adapted to human perception.

The presentation of the position retrieval information may be done in a manner that is particularly suitable for human perception, e.g. by displaying different aspects of the region of interest of a sample in multiple graphical views, e.g., by displaying portions of the sample in an appropriate subpixel position and allowing a human to mark a “position” in that display determined by interpolation of surrounding measurement points.

In electron microscopy, particularly in the techniques mentioned at the outset such as focused ion beam electron microscopy, a generally flat sample may be observed from an angle, resulting in a perspective view of the sample and a corresponding digital image. In contrast, in a light microscope, the sample is imaged in a plane orthogonal to the optical axis of the microscope objective. In other words, the sample image in electron microscopy, at least of the types under consideration herein, are slanted as compared to the light microscopic imaged, as illustrated in connection with FIG. 6. A method according to an embodiment of the present invention may take this into account such that, when the digital sample representation is provided in a perspective view or slanted view as explained, the distance representations are preferably provided in the same perspective view as apparent ellipses. On the other hand, when the digital sample representation is provided in a top view, the digital distance representations are preferably provided in the same top view as circles. For providing the possibility of a perspective view, a three-dimensional image acquisition in a light microscope may be performed and coordinates of the corresponding markers, positions, etc. may be provided as three-dimensional coordinates.

Repeating what was already stated above, identifying the feature in the sample representation as potentially being the target position and/or the potential one of the reference markers as being one of the reference markers may include performing a pattern comparison of a pattern potential reference markers with the plurality of reference position identifiers, either being performed by a user, or supported by or supporting a user, or performed fully automatically using a pattern recognition algorithm.

Such a pattern recognition may be preceded by a step restricting possible pattern orientations using the reference markers. In particular embodiments, as soon as two (potential) reference markers have been identified, possible orientations of a pattern are significantly restricted and essentially can only be present in the form of orientations rotated around an axis between the two (potential) reference markers identified. Therefore, a corresponding embodiment may include identifying two of the reference position indicators and rotating the corresponding set of geometric descriptors around an axis between these reference markers. At one rotational position, the set of geometric descriptors must then match the actual reference indicators and the target position and may therefore easily and straightforwardly be recognized, if the two reference markers have been correctly identified. Be it noted that the target position and the reference positions may not be arranged in a single plane but may also be arranged at different positions in the three-dimensional space, but possible orientations and positions in the three-dimensional space are gradually limited when proceeding according to an embodiment of the present invention.

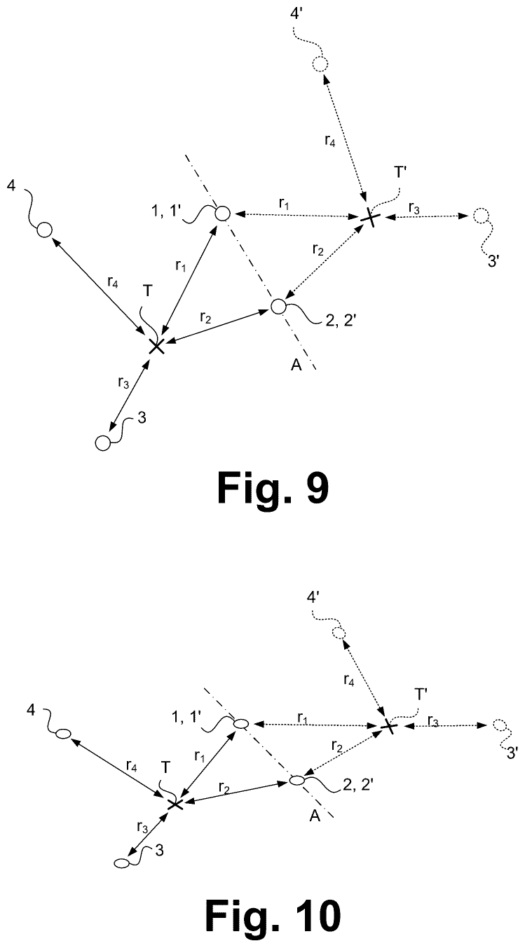

FIG. 9 illustrates how such a gradual restriction of possible orientations may be used in an embodiment of the present invention. Particularly, this FIG. 9 illustrates how this restriction ultimately leaves the possibility for rotating a geometrical descriptor set around one axis in the three-dimensional space as shown in a projection to a plane view. As mentioned before, a pattern comparison according to an embodiment of the present invention may particularly be preceded by a step restricting possible pattern orientations using the reference markers 102a to 102d as essentially described above and again shown here. As shown here, as soon as two (potential) reference markers, here reference markers 1 and 2, or their corresponding identifiers, have been identified, possible orientations of a pattern are significantly restricted and essentially can only be present in the form of orientations rotated around an axis A between the two (potential) reference markers identified. In the two-dimensional space illustrated, the “rotation” around the axis, corresponds to a “flipping” of the pattern at the axis A. Positions of the target and reference marker identifiers T and 1 to 4 mirrored accordingly are indicated with T′ and 1′ to 4′.

Again, as a sample surface is often observed from an elevation angle, i.e. slanted in a certain angle vis-à-vis a line orthogonal to its surface in an electron microscope, FIG. 10 illustrates what was already explained in connection with FIG. 10 in a perspective view.

As also mentioned above, some of the steps according to embodiments of the present invention may be repeatedly be performed, thereby identifying one potential reference marker as being a true reference marker one after the other. This particularly relates to specifying a (further) potential one of the reference markers associated to the target position in the sample representation, providing (further) digital distance representations of the individual reference marker distances of the plurality of reference markers associated to the target position in the form of rotational traces coaxially centred around the (further) potential one of the reference markers specified, and identifying a feature in the sample representation as potentially being the target position and/or the potential (further) one of the reference markers as being one of the reference markers on the basis of an evaluation of the sample representation and the digital distance representations. These steps may be performed one or a plurality of further times including specifying one or a plurality of further potential ones of the reference markers associated to the target position in the sample representation.

Digital distance representations may be provided, in this connection, whenever the corresponding method step is performed and identifying the feature in the sample representation as potentially being the target position may, after a sufficient plurality of potential reference identifiers is obtained, include identifying intersections between the digital distance representations. As explained further below with reference to the drawing, such intersections may identify a position of the target position.

Embodiments of the present invention may also include determining a quality descriptor indicating a match between the set of geometric descriptors and the target position and reference markers and using this quality descriptor to describe a shrinkage and/or linear or nonlinear distortion of the sample. For example, if some of the distances show a higher degree of matching and others a lower degree of matching, this is an indication of a nonlinear shrinkage.

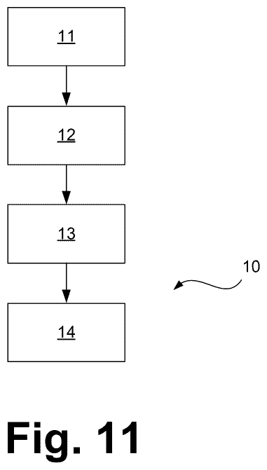

FIG. 11 illustrates a method according to an embodiment of the present invention in the form of a flow diagram which is designated 10. As to the method 10, reference is made to the explanations above, and particularly to the explanations for FIGS. 2 to 8.

Briefly repeating what was said above, method 10 is performed, in embodiments of the present invention, for retrieving a target position 101 in a microscopic sample 100 (see particularly FIG. 1) in an electron microscope 2500 using position retrieval information. The position retrieval information comprise, associated to the or each of the plurality of target positions 101, a set of geometric descriptors 200 (see particularly FIG. 2) describing a spatial relation between a target position identifier T corresponding to the target position 101 and a plurality of reference position identifiers 1 to 4 corresponding to positions of a plurality of reference markers 102a to 102d associated to and identifiable in individual reference marker distances to the target position 101 in the microscopic sample 100.

Method 10 comprises, in the embodiment shown in FIG. 11, for the target positions 101 a first step 11 of providing a digital sample representation 510 of the sample 100 or a region thereof expected to include the target position 101, thereafter a second step 12 of specifying a potential one of the reference markers 101 associated to the target position 101 in the sample representation 510, followed by a third step 13 of providing digital distance representations 520 of the individual reference marker distances of the plurality of reference markers 102a to 102d associated to the target position 101 in the form of rotational traces coaxially centred around the potential one of the reference markers 101 (see particularly FIGS. 5 to 8). On this basis, subsequently a fourth step of identifying 14 a feature in the sample representation 510 as potentially being the target position 101 and/or the potential one of the reference markers 101 as being one of the reference markers 101 on the basis of an evaluation of the sample representation 510 and the digital distance representations 520 is performed.

In embodiments of the method for examining and/or processing a target position in a microscopic sample using an examination apparatus, the target position may be retrieved in the examination apparatus on the basis thereof in any of the embodiments of the invention explained above.

Said examining and/or processing may, according to particular embodiments of the present invention include operating on said regions using a focused ion beam in focused ion beam scanning electron microscopy. That is, an electron microscope used in such a method is particularly a focused ion beam electron microscope adapted to process the sample at the one or the plurality of target positions using a focused ion beam. Reference is made to the explanations at the outset.

In particular embodiments, such a method may further comprise providing the position retrieval information using a plurality of process steps on the basis of images provided by a light microscopic device. Details will be explained below.

A microscopic examination arrangement comprising a microscopic device and a computing device according to an embodiment of the present invention, is adapted to perform a method as explained in embodiments before.

FIG. 12 illustrates a computerized microscope system 2000 which may be used in embodiments of the present invention.

The microscope system 2000 may be configured to perform a method described herein. The system 2000 comprises a microscope 2100 and a computer system 2200. The microscope 2100 is configured to take images and is connected to the computer system 2200 by means of a wired or wireless communication path 2300.

The computer system 2200 is configured to execute at least a part of a method described herein. The computer system 2220 and the microscope 2100 may be separate entities but can also be integrated together in one common housing. The computer system 2200 may be part of a central processing system of the microscope 2100 and/or the computer system 2200 may be part of a subcomponent of the microscope 2100, such as a sensor, an actor, a camera or an illumination unit, etc. of the microscope 2100.

The computer system 2220 may be a local computer device (e.g. personal computer, laptop, tablet computer or mobile phone) with one or more processors and one or more storage devices or may be a distributed computer system (e.g. a cloud computing system with one or more processors and one or more storage devices distributed at various locations, for example, at a local client and/or one or more remote server farms and/or data centers). The computer system 2200 may comprise any circuit or combination of circuits.

In one embodiment, the computer system 2220 may include one or more processors which can be of any type. As used herein, processor may mean any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, a field programmable gate array (FPGA), for example, of a microscope or a microscope component (e.g. camera) or any other type of processor or processing circuit. Other types of circuits that may be included in the computer system 2200 may be a custom circuit, an application-specific integrated circuit (ASIC), or the like, such as, for example, one or more circuits (such as a communication circuit) for use in wireless devices like mobile telephones, tablet computers, laptop computers, two-way radios, and similar electronic systems.

The computer system 2200 may include one or more storage devices, which may include one or more memory elements suitable to the particular application, such as a main memory in the form of random access memory (RAM), one or more hard drives, and/or one or more drives that handle removable media such as compact disks (CD), flash memory cards, digital video disk (DVD), and the like. The computer system 2200 may also include a display device, one or more speakers, and a keyboard and/or controller, which can include a mouse, trackball, touch screen, voice-recognition device, or any other device that permits a system user to input information into and receive information from the computer system 2200.

As illustrated in FIG. 12, computer system 2200 comprises a keyboard and/or a touchpad 2210 adapted to make selections on a screen 2220 on which a graphical user interface 1000 for performing one, some or all method steps according to any embodiment of the invention may be displayed.

The microscope is shown to comprise, among others, a microscope stand 2110, a stage 2120 on which a sample 100 may be placed, at least one objective or lens 2130, an eyepiece 2140, a tubus 2150, a camera (system) 2160, and an illumination device 2170.

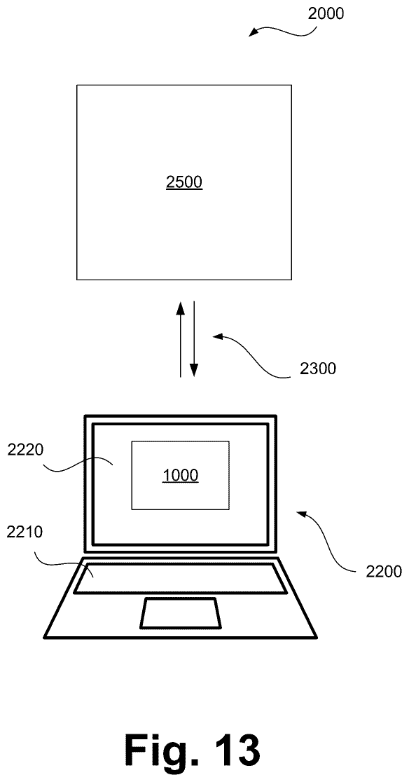

In FIG. 13, a microscope arrangement again indicated with reference numeral 2000 is shown in a configuration wherein the microscope arrangement 2000 comprises an electron microscope 2500, particularly an electron microscope adapted to provide a focused ion beam for operating on a sample. A computer system 2200 as essentially described in connection with FIG. 12 is part of the microscope arrangement 2000.

Microscope arrangement 2000 may particularly be adapted to perform a method such as the method 10 illustrated in FIG. 11, i.e. a method for retrieving one or a plurality of target positions 101 in a microscopic sample 100 (see particularly FIG. 1) in the electron microscope 2500 using position retrieval information. As described before, in embodiments of the present invention the position retrieval information comprise, associated to the or each of the plurality of target positions 101, a set of geometric descriptors 200 (see particularly FIG. 2) describing a spatial relation between a target position identifier T corresponding to the target position 101 and a plurality of reference position identifiers 1 to 4 corresponding to positions of a plurality of reference markers 102a to 102d associated to and identifiable in individual reference marker distances to the target position 101 in the sample 100.

Further aspects of method steps performed in the microscope arrangement 2000 have extensively been described before, particularly in connection with FIGS. 3 to 8.

A computer program with program code for performing a method as described before when the computer program is run on a processor is also part of the present invention.

Some or all of the method steps may be executed by (or using) a hardware apparatus, like for example, a processor, a microprocessor, a programmable computer or an electronic circuit. In some embodiments, some one or more of the most important method steps may be executed by such an apparatus.

Depending on certain implementation requirements, embodiments of the invention can be implemented in hardware or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may, for example, be stored on a machine readable carrier.

Other embodiments comprise the computer program for performing one of the methods described herein, stored on a machine readable carrier.

In other words, an embodiment of the present invention is, therefore, a computer program having a program code for performing one of the methods described herein, when the computer program runs on a computer.

A further embodiment of the present invention is, therefore, a storage medium (or a data carrier, or a computer-readable medium) comprising, stored thereon, the computer program for performing one of the methods described herein when it is performed by a processor. The data carrier, the digital storage medium or the recorded medium are typically tangible and/or non-transitionary. A further embodiment of the present invention is an apparatus as described herein comprising a processor and the storage medium.

A further embodiment of the invention is, therefore, a data stream or a sequence of signals representing the computer program for performing one of the methods described herein. The data stream or the sequence of signals may, for example, be configured to be transferred via a data communication connection, for example, via the internet.

A further embodiment comprises a processing means, for example, a computer or a programmable logic device, configured to, or adapted to, perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example, a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

As used herein the term “and/or” includes any and all combinations of one or more of the associated listed items and may be abbreviated as “/”.

Although some aspects have been described in the context of a method, it is clear that these aspects also represent a description of the corresponding device, where a method step or a feature of a method step corresponds to a block or device or a component thereof. Analogously, aspects described in the context of a feature of a corresponding apparatus also represent a description of a method step.

Hereinbelow, while not necessarily forming part of the embodiments of the present invention, some aspects of providing the position retrieval information to be used according to embodiments of the present invention, particularly in a light microscope, will be briefly described. Further details may be found in a co-filed patent application by the present applicant entitled “Method for providing position information for retrieving a target position in a microscopic sample, method for examining and/or processing such a target position and means for implementing these methods” the contents of which are incorporated herein by reference.

Providing the position retrieval information may include a workflow which may particularly include to create an overview scan of the sample to find cells or objects of interest. The overview scan can optionally be provided with or in the form of a focus map, i.e. different regions of the overview scan may be provided in different focus positions so that preferably all images of the overview scan are in focus. The overview scan can, particularly be presented to a user in a suitable graphical user interface (GUI) in a corresponding overview region.

In more general terms, a method for providing position information for retrieving a target position in a microscopic sample may be used which comprises, as a first step, providing a first digital representation (the overview scan just mentioned) of the sample or a part thereof at a first resolution including the target position. The first resolution is, as also further explained below, in particular embodiments not higher than an optical resolution of an instrument used in providing the first digital representation (the overview scan) and may be lower.

In a next step of the workflow, a coarse or rough marking of a region of interest or target position may be performed by a user in the overview scan. Each of such regions or positions marked by the user may later on be worked on as further explained below.

Again, in more general terms, for the target position or region of interest, an initial step of specifying a first target position identifier in the first digital representation indicating the target position at the first resolution may be performed. This identification may particularly be made by a user clicking to a certain position in the first digital representation or overview scan just mentioned.

For the target position thus identified, according to the present invention, an image stack or Z-stack is then obtained which initially includes images at the corresponding target region identified and at the first resolution.

The term “image stack” (or Z-stack) as used herein shall refer to a stack of images of the same or essentially the same region of an object, which are acquired at different focus or lens distances using an optical imaging method. An image stack may be used to form a three-dimensional representation of the region, or images of the image stack may be merged to give a resulting image with a greater depth of field (DOF) than any of the individual images of the image stack. For the avoidance of doubt, the term “image stack” shall refer to a plurality of images obtained accordingly and not a merged image or a derived three-dimensional representation generated based on the individual images. All features of the images of an image stack may be in focus, such as in a confocal instrument, or these may, such as in a wide-field instrument, comprise in-focus and out-of-focus features. In more general terms, an “image stack” is a plurality of images without intended lateral (X, Y) displacement but acquired at different Z positions.

Again expressed in more general terms, for the target position identified in the manner explained above, an image stack in a region of the sample including the target position indicated by the first target position identifier (but advantageously no further target position(s)) may be identified.

An aspect herein is to provide (artificial) data with a higher resolution than the first resolution, i.e. particularly higher than the resolution of an optical instrument used in obtaining the first digital representation or overview scan. This is particularly realized by performing a deconvolution between pixels of the individual images of the image stack, but also between pixels of different images of the same image stack.

The approach used here may also be considered to resemble a kind of “optical zooming” which (apparently) increases the resolution of the image obtained. Be it noted that a resolution-increased image does typically not provide additional information in the form of resolved features of the sample (i.e. it is, in classical optical or microscopic terms, an “empty magnification”). However, despite this, it allows a user, in the resolution-increased image data, to select a region of interest at a higher resolution than before in that he or she may point, particularly in borderline cases, to positions “between” certain pixels, which would not have been possible without such a resolution increase.

The resolution increase, in particular embodiments, includes a deconvolution method and a suitable definition for an image stack experiment, which may particularly be loaded once a user has performed a region of interest selection, and which may contain instructions for deconvolution.

When a graphical user interface is used as mentioned before, a detail viewer or detail viewing region may show deconvolution or resolution-increased data in a user-accessible way, particularly in form of slices or other two-dimensional representations, such as cross-sections, of three-dimensional data, and an overview region already mentioned above may show the raw data.

In summarizing what was just explained, for the target position identified in the manner explained above, a second digital representation at a second resolution higher than the first resolution based on the image stack may be provided.

A plurality of reference position identifiers may be specified in the second digital detail representation, the reference position identifiers indicating positions of visible optically detectable reference markers.

As mentioned, a user may, in the higher-resolution image or any representation derived therefrom, again identify the target position(s) but, in this case, due to the fact that said definition is performed in the higher-resolution image or representation, at a higher resolution as before, i.e. as in the overview scan or first digital representation.

That is, for the target position identified in the manner explained above, contained in an image stack, and preferably presented to the user, the method comprises specifying a second target position identifier in the second digital representation indicating the target position at the second resolution.

In particular embodiments, in the higher-resolution image or any representation derived therefrom, in such a step, a fine positioning is therefore realized, particularly in a corresponding region of the graphical user interface. The aim here is to achieve the highest possible “spatial resolution”. At the same time, orientation points are to be defined which are the positions of (at least some of the) reference markers already explained above. Particularly, these are oriented in a random, and thus a recognisable distribution pattern such that a user can later retrieve at least some of the positions of the reference markers.

For the target position identified in the manner explained above, and the corresponding image stack or rather the images derived therefrom and being presented to the user at the second resolution, a plurality of reference position identifiers in the second digital detail representation indicating positions of optically detectable reference markers at the second resolution may therefore be specified.

In performing the method steps above or on the basis thereof, for each of the target positions, a set of geometric descriptors describing spatial relations between the second target position identifier and the plurality of reference position identifiers may be defined to provide the position retrieval information according to the present invention. These geometric descriptors were already explained above and will be further explained below. They may e.g. be provided in the form of graphs, vector sets, etc. They may be normalized, e.g. distances between the target position identifier and the reference position identifiers may be calibrated to the largest or smallest length.

The method discussed before is, in particular embodiments, adapted to provide a plurality of target positions in the same manner as described for one target position before. Expressed in other terms, the target position referred to before may be a first target position and the method may be adapted for providing position information for retrieving one or more further target positions by performing the steps for the or each of the further target positions. In this connection, the regions of the sample in which the image focus stacks are acquired for the first and the or each of the further target positions are particularly disjoint regions. That is, the images of different image stacks, i.e. of image stacks obtained for different target regions, particularly do not overlap, i.e. they particularly are acquired for disjoint regions of the sample or of the overview scan obtained. As, according to particular embodiments of the present invention, the images of different focus stacks do not overlap, each individual region of interest preferably corresponds to one focus stack. A particularly advantage of this is that each target position or position of interest is surrounded (only) by “its own” markers and as such individual patterns may be generated, simplifying pattern recognition by a user.

The geometric descriptor set may, according to a particular embodiment of the present invention, be determined as a vector set or directed graph and/or the position information may be provided in the form of coordinates relative to a reference point determined on the basis of or relating to the vector set or directed graph. As to graphs and further definitions thereof, reference is made to textbooks relating to graph theory. Particularly, a graph according to the present invention or an embodiment thereof may consist of two types of nodes, a node L relating to the region of interest and a plurality of nodes B relating to the reference point position. The number of nodes L in a graph according to an embodiment of the invention is 1. The number of nodes B in graph is, according to an embodiment of the invention greater than 0, and, for being used according to the invention, preferably larger than 2, 3, 4 or 5 and up to 10.

A corresponding graph is, viewed from a first perspective, preferably coherent, all nodes B have a node degree of 1, node L has node degree of B (number of nodes B), the graph is undirected (in general), and the minimum path length between two nodes B is 2. A corresponding graph is, viewed from a second perspective, preferably coherent, nodes B form a cycle, nodes B form an Eulerian circle, the path length is B−1, and the node degree of B is 2. Viewed from a third perspective, a corresponding graph is preferably coherent, all B nodes b have a node degree of 1, node L has node degree B (number), the number of nodes L is 1, the number of nodes B is greater than 0, and each edge is marked with the weight of a vector. Finally, and as viewed from a fourth perspective, a corresponding graph is preferably coherent, the nodes B form a cycle, the nodes B form an Eulerian circle, the path length is B−1, the degree of nodes B is 2, and each edge is marked with the weight of the difference vector of the adjacent beads. In an example where the number of nodes B is 6, six paths from node L to nodes B are present and these preferably comprise different lengths. An orientation of a graph maybe defined, in such an embodiment, as the direction of the longest path. Further and alternative definitions may also apply.

With regard to processing and using the geometric descriptors in a further method, such as in an electron microscopy method, which may or may not be form part of embodiments of the present invention, reference is made to the explanations below. Particularly, providing the position retrieval information includes modifying the geometric descriptors based on an estimate of a shrinkage of the sample in a subsequent process. This embodiment is of particular advantage if an electron microscopy method is used for further examination and/or processing.

The previous explanations were essentially based on the (simplified) assumption that a linear, affine transformation condition between light microscope and electron microscope may be present in which points, straight lines, planes and parallel lines between light microscope and electron microscope are preserved. However, embodiments of the present invention may particularly be used with frozen samples at below −140° C. As a biological cell consists essentially of water, at −140° C. its major constituent is essentially ice. In addition, the cell is covered by an additional ice layer or ice cap. If ice is brought into a vacuum (as in electron microscopy), parts of the ice can sublime directly to the gas phase (freeze-drying effect). Certain parts of the ice are thus removed from the sample by sublimation. Therefore, the cell can shrink in the Z direction (and also in the X, Y directions). This changes the locations of the target position and also of the reference positions. While in a light microscope one can determine the Z position because it can be seen to fluoresce through the ice, this is not possible in electron microscopy because the ice layer present is not sufficiently transparent to electrons in its typical thickness.

In other words, in light microscopy the height of the target position as well as heights of a sample carrier carrying the sample (lowest point) and the ice cap (highest point) can be determined, while in electron microscopy only the heights of the sample carrier (lowest point) and the ice cap (highest point) can be determined. However, according to such an embodiment of the present invention, modifying the geometric descriptors based on an estimate of a shrinkage of the sample in a subsequent process may be based on determining a relative height of the target position in the height span between the sample carrier and the ice cap before performing the subsequent process (in the example explained above in light microscopy which is used for determining the set of (unmodified) geometric descriptors), determining the height of the sample carrier and the ice cap in the subsequent process (such as electron microscopy), and estimating the height of the target position resulting from said shrinkage using the relative height therebetween, which is estimated to be comparable to the relative height in the unshrunk sample.

Expressed in more general terms, modifying the geometric descriptors based on an estimate of a shrinkage of the sample in a subsequent process may include determining a relative height of the target position between a first and a second reference height (in the example explained the sample carrier and the ice cap) for an unshrunk sample wherein the first and second reference heights are particularly optically detected, determining the first and a second reference height in the subsequent process, i.e. for the shrunk sample, and deriving an estimate of the height of the target position from the relative height of the target position determined for the unshrunk sample and the first and a second reference height in the subsequent process, i.e. for the shrunk sample.

The present invention also relates to a method for examining and/or processing a target position in a microscopic sample using an examination apparatus, wherein position retrieval information for the target position is provided by a method as described in various embodiments before, and wherein the target position is retrieved in the examination apparatus on the basis thereof. While the explanations hereinbefore were given with the understanding that a linear affine transformation, i.e. by rotation, translation and scaling, is possible and sufficient to perform a pattern comparison, embodiments of the present invention can likewise be used when a sample, between definition and using the geometrical descriptor sets, changes non-linearily. In this case, then strictly speaking a linear transformation can no longer be used. Therefore, an aspect of the present invention includes, when a pattern recognition was made, examining a quality criterion describing to what extent a pattern searched and a pattern recognized match. If a sufficient match is found, at least for one position of the sample, one can assume that the affine transformation at this position was linear and the sample was not distorted at this position. If a quality criterion defined accordingly is determined to be below a threshold, for example, a certain warning can be given to the user.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

10 method
11 providing digital sample representation
12 specifying potential reference marker
13 providing digital distance representations
14 identifying feature in sample representation
100 microscopic sample
101 target position
102a-102d reference markers
102′ further reference markers
103 wrong reference marker
110 cell
111 protoplasm
112 nucleus
200 set of geometrical descriptors
T target position identifier
1-4 reference position identifiers
l′-4′ reference position identifiers, mirrored
R1 minimum distance
R2 maximum distance
c₁-c₄ rotational traces
r₁-r₄ radii of rotational traces
510 digital sample representation
520 digital distance representations
1000 graphical user interface
1100 display region
2000 microscope system
2100 microscope
2110 microscope stand
2120 microscope stage
2130 objective, lens
2140 eyepiece
2150 tubus
2160 camera
2170 illumination device
2200 microscope
2210 keyboard, touchpad
2220 screen
2300 communication path
2500 electron microscope

1. A method for retrieving a target position in a microscopic sample in an examination apparatus using position retrieval information, the position retrieval information comprising, associated to the target position, a set of geometric descriptors describing a spatial relation between a target position identifier corresponding to the target position and a plurality of reference position identifiers corresponding to positions of a plurality of reference markers associated to and identifiable in individual reference marker distances to the target position in the microscopic sample, the method comprising:
a) providing a digital sample representation of the sample or a region thereof expected to include the target position;
b) specifying a potential one of the reference markers associated to the target position in the digital sample representation;
c) providing digital distance representations of the individual reference marker distances of the plurality of reference markers associated to the target position in a form of rotational traces coaxially centred around the potential one of the reference markers specified; and
d) identifying a feature in the digital sample representation as potentially being the target position based an evaluation of the digital sample representation and the digital distance representations.

2. The method according to claim 1, wherein the digital sample representation and the digital distance representations are provided in an overlaid manner in a display region of a graphical user interface rendered by a computing device on a display.

3. The method according to claim 2, wherein specifying the potential one of the reference markers associated to the target position in the digital sample representation comprises receiving and processing a user input of a user of the computing device indicating a position in the display region.

4. The method according to claim 3, wherein the digital sample representation is provided in a perspective view and wherein the distance representations are provided in the perspective view as apparent ellipses.

5. The method according to claim 3, wherein the digital sample representation is provided in a top view and wherein the digital distance representations are provided in the top view as circles.

6. The method according to claim 1, wherein identifying the feature in the digital sample representation as potentially being the target position comprises performing a pattern comparison of a pattern of the potential reference markers with the plurality of reference position identifiers.

7. The method according to claim 6, wherein the pattern comparison is preceded by a step restricting possible pattern orientations using the plurality of reference markers.

8. The method according to claim 1, wherein method steps b) to d) are performed one or a plurality of further times, comprising specifying one or a plurality of further potential ones of the reference markers associated to the target position in the sample representation.

9. The method according to claim 8, wherein the digital distance representations are provided whenever method step b) is performed and wherein identifying the feature in the sample representation as potentially being the target position comprises identifying intersections between the digital distance representations.

10. The method according to claim 1, wherein the set of geometric descriptors and/or the digital distance representations are geometrically adapted to compensate for a shrinkage of the sample.

11. The method according to claim 1, wherein a quality descriptor indicating a match between the set of geometric descriptors and the target position and the reference markers is determined and used to describe at least one of a shrinkage and a linear or a nonlinear distortion of the sample.

12. A method for examining and/or processing a microscopic sample at the target position in the microscopic sample using an examination apparatus, comprising retrieving the target position using the method according to claim 1.

13. The method according to claim 12, wherein the examination apparatus is a focused ion beam electron microscope adapted to process the sample at the target position using a focused ion beam or a laser microdissection apparatus adapted to process the sample at the target position using a laser beam.

14. The method according to claim 12, wherein the method further comprises providing the position retrieval information using a plurality of process steps based on images provided by a light microscopic device.

15. An apparatus being adapted to perform the method according to claim 1.

16. A microscopic examination and/or processing arrangement comprising an examination apparatus and a computing device, the arrangement being adapted to perform the method according to claim 1.

17. A non-transitory computer readable medium comprising processor executable instructions stored thereon that, when executed by one or more processors, facilitate the execution of the method according to claim 1.

18. A method for retrieving a target position in a microscopic sample in an examination apparatus using position retrieval information, the position retrieval information comprising, associated to the target position, a set of geometric descriptors describing a spatial relation between a target position identifier corresponding to the target position and a plurality of reference position identifiers corresponding to positions of a plurality of reference markers associated to and identifiable in individual reference marker distances to the target position in the microscopic sample, the method comprising:
a) providing a digital sample representation of the sample or a region thereof expected to comprise the target position:
b) specifying a potential one of the reference markers associated to the target position in the digital sample representation:
c) providing digital distance representations of the individual reference marker distances of the plurality of reference markers associated to the target position in a form of rotational traces coaxially centred around the potential one of the reference markers specified; and
d) identifying a feature in the potential one of the reference markers as being one of the reference markers based on an evaluation of the digital sample representation and the digital distance representations.

19. The method according to claim 1, wherein identifying the feature in the potential one of the reference markers as being one of the reference markers comprises performing a pattern comparison of a pattern of the potential reference markers with the plurality of reference position identifiers.
